(19) United States
(12) Patent Application Publication
(10) Pub. No.: US 2019/0114990 A1
(43) Pub. Date: Apr. 18, 2019

(54) Vehicle Label Presentation Method, Device and System

(71) Applicant: BOE TECHNOLOGY GROUP CO., LTD., Beijing (CN)

(72) Inventors: Weiguo LI, Beijing (CN); Tianyue ZHAO, Beijing (CN)

(21) Appl. No.: 16/117,735

(22) Filed: Aug. 30, 2018

(30) Foreign Application Priority Data
Oct. 12, 2017 (CN) 201710948912.5

(51) Int. Cl. G09G 5/00

(52) U.S. Cl. CPC G09G 5/006; G09G 2370/16; G09G 2380/04; G09G 2380/10; G09F 3/203; G09G 2380/02; G09G 2360/144; G09G 2320/0626; G09G 2354/00

(57) ABSTRACT

The present disclosure discloses a vehicle label presentation method, device and system. The vehicle label presentation method includes: determining that a presentation trigger condition is reached; and presenting a stored vehicle label in a set manner.

### CROSS-REFERENCE TO RELATED APPLICATION

This application claims priority from Chinese patent application No. 201710948912.5 filed with the China Patent Office on Oct. 12, 2017, the disclosure of which is incorporated herein by reference in its entirety.

### TECHNICAL FIELD

The present disclosure relates to a technical field of electronic label display technology, and particularly relates to a vehicle label presentation method, device and system.

### BACKGROUND

At present, labels relating to motor vehicle annual inspection, compulsory automobile liability insurance, environmental protection, etc., are paper labels printed by the corresponding agencies and then pasted by the vehicle owner to a fixed area of the front windshield of the motor vehicle for verification.

However, as time goes by, the paper labels would be affected by sunray and become faded, resulting in poor information recognition. Meanwhile, paper labels to some extent block the driver's view, hiding some latent safety hazards in driving.

### SUMMARY

The present disclosure has been accomplished in order to at least partially solve the technical problem in the related art. The present disclosure provides a vehicle label presentation method, device and system capable of presenting vehicle labels through an electronic device.

According to an aspect of the present disclosure, there is provided a vehicle label presentation method including:

determining that a presentation trigger condition is reached; and

presenting a stored vehicle label in a set manner.

In some embodiments, the step of presenting a stored vehicle label in a set manner includes:

displaying the stored vehicle label on a display.

In some embodiments, the step of presenting a stored vehicle label in a set manner includes:

transmitting the stored vehicle label through a wireless signal.

In some embodiments, the presentation trigger condition includes at least one of the following conditions:

turning on a device;

receiving a presentation command; and

detecting a read command through a wireless signal.

In some embodiments, the vehicle label presentation method further includes:

acquiring and storing a vehicle label input or transmitted by an authorized user in a case where a setting command transmitted by the authorized user is received.

In some embodiments, the vehicle label presentation method further includes:

acquiring and storing a term information of the vehicle label input or transmitted by an authorized user in a case where a setting command transmitted by the authorized user is received; and

reminding a vehicle owner in a case where a remaining term of the vehicle label is shorter than a set period of time.

In some embodiments, in a case where a plurality of vehicle labels are stored, displaying the stored vehicle label on the display includes one of the following manners:

displaying the plurality of vehicle labels simultaneously in different areas of the display; and

displaying the plurality of vehicle labels alternately on the display.

In some embodiments, in a case where a plurality of vehicle labels are stored, transmitting the stored vehicle label through the wireless signal includes:

acquiring a read command through the wireless signal; and

transmitting a corresponding vehicle label to a vehicle label inspection device according to the read command.

According to another aspect of the present disclosure, there is provided a vehicle label presentation device, including:

a determining unit configured to determine that a presentation trigger condition is reached; and

a presentation unit configured to present a stored vehicle label in a set manner.

In some embodiments, the presentation unit is configured to display the stored vehicle label on a display.

In some embodiments, the presentation unit is configured to transmit the stored vehicle label through a wireless signal.

In some embodiments, the presentation trigger condition includes at east one of the following conditions:

turning on a device;

receiving a presentation command; and

detecting a read command through a wireless signal.

In some embodiments, the vehicle label presentation device further includes:

a setting unit configured to acquire and store a vehicle label input and transmitted by an authorized user in a case where a setting command transmitted by the authorized user is received.

In some embodiments, the setting unit is further configured to acquire and store a term information of a stored vehicle label, and remind the vehicle owner in a case where the remaining term of the vehicle label is shorter than a set period of time.

In some embodiments, in a case where a plurality of vehicle labels are stored, the presentation unit is configured to display the stored vehicle labels on the display in one of the following manners:

displaying the plurality of vehicle labels simultaneously in different as of the display; and

displaying the plurality of vehicle labels alternately on the display.

In some embodiments, in a case where a plurality of vehicle labels are stored, the presentation unit is configured to acquire a read command through a wireless signal, and transmit a corresponding vehicle label to a vehicle label inspection device according to the read command.

In some embodiments, the display is a display formed of a flexible transparent material.

In some embodiments, the vehicle label presentation device further includes:

a light sensor configured to detect an ambient brightness to adjust a display brightness of the display.

According to still another aspect of the present disclosure, there is provided a vehicle label presentation system including:

the vehicle label presentation device described above configured to transmit a stored vehicle label through a wireless signal in a case where it is determined that a trigger condition to transmit the vehicle label is reached; and

a vehicle label inspection device configured to receive a vehicle label transmitted by the vehicle label presentation device, and inspect a vehicle according to the vehicle label.

In some embodiments, the presentation trigger condition to transmit the vehicle label includes at least one of the following conditions:

turning on a device;

receiving a command to transmit a vehicle label; and

acquiring a read command transmitted by a vehicle label inspection device through a wireless signal.

### BRIEF DESCRIPTION OF DRAWINGS

Other features, objects, and advantages of the present disclosure will become more apparent from a reading of the following detailed description of the non-limiting examples with reference to the following drawings. In the drawings:

FIG. 1 is a flowchart showing a vehicle label presentation method according to an exemplary embodiment of the present disclosure;

FIG. 2 is a flowchart showing a vehicle label presentation method according to an exemplary embodiment of the present disclosure;

FIG. 3 is a flowchart showing a vehicle label inspection method according to an exemplary embodiment of the present disclosure;

FIG. 4 is a block diagram showing a configuration of a vehicle label presentation device according to an exemplary embodiment of the present disclosure;

FIG. 5 is a block diagram showing a configuration of a vehicle label presentation device according to an exemplary embodiment of the present disclosure;

FIG. 6 is a block diagram showing a configuration of a vehicle label inspection device according to an exemplary embodiment of the present disclosure;

FIG. 7 is a block diagram showing a configuration of a vehicle label presentation system according to an exemplary embodiment of the present disclosure; and

FIG. 8 is a block diagram showing a configuration of a vehicle label presentation apparatus according to an exemplary embodiment of the present disclosure.

### DETAILED DESCRIPTION

Hereinafter, the present disclosure will be described in detail in conjunction with the accompany drawings and exemplary embodiments. It can be appreciated that the exemplary embodiments described herein are intended to explain the present disclosure only, rather than to restrict the present disclosure. Further to be noted is that only parts related to the present disclosure are illustrated in the drawings for the convenience of description.

It should be illustrated that, without conflict, the exemplary embodiments in the application and the features of the exemplary embodiments can be randomly combined with each other. The present application will now be described in detail with reference to the drawings in conjunction with the exemplary embodiments.

As shown in FIG. 1, the present disclosure provides a vehicle label presentation method, including:

Step S101, determining that a presentation trigger condition is reached; and

Step S102, presenting a stored vehicle label in a set manner.

Through such a vehicle label presentation method, the stored vehicle label may be presented in a set manner when it is determined that a presentation trigger condition is reached, so as to realize presentation of the vehicle label through an electronic device. In this way, new paper labels are no longer to be pasted to the windshield every year, not to mention the fading of the labels, and meanwhile blocking of the driver's view can be reduced.

In an exemplary embodiment of the present disclosure, presenting a stored vehicle label in a set manner in step S102 specifically includes:

displaying the stored vehicle label on a display, and/or transmitting the stored vehicle label through a wireless signal.

In order to allow the viewer to view the vehicle label, the stored vehicle label may be displayed on the display such that everyone can view the vehicle label indiscriminately even without any viewing tool. Hence, more convenient viewing of the vehicle label can be achieved by displaying the stored vehicle label on the display.

The stored vehicle label may be pushed through a wireless signal without being restricted by the display, such that blocking of the windshield is prevented. The wireless signal may be an NFC signal, a Bluetooth signal, an infrared signal, or other wireless signals that can perform communication.

In order to make the display better fit the windshield and to avoid blocking of the windshield for better display effect, the display may be a display made of a transparent flexible display material.

When in actual use, the stored vehicle label may be presented upon turning-on of the device or upon receipt of a presentation command by a user after the device is turned on, or may be displayed by the display upon detection of a read command through a wireless signal, and/or may be pushed through a wireless signal.

As can be seen, the presentation trigger condition in step S101 may include one of the following conditions:

turning on a device;

receiving a presentation command; and

detecting a read command through a wireless signal.

When the vehicle label presentation device receives the presentation command or detects the read command through the wireless signal, the stored vehicle label is displayed through a display, and after a set presentation time is reached, the display is automatically turned off, so as to save electric energy.

When a vehicle goes through annual inspection or other inspections, the vehicle label generally needs to be updated. A new vehicle label may be written and stored in a ROM by the relevant authority through NFC channel, or be encrypted and written to a memory card, so that the maintenance is safe and easy.

At this time, the vehicle label presentation method further includes:

acquiring and storing a vehicle label input or transmitted by an authorized user upon receipt of a setting command transmitted by the authorized user.

In an exemplary embodiment of the present disclosure, the vehicle label such as a vehicle annual inspection label is a vehicle label with an expiration date that can remind the vehicle owner when the vehicle label is about to expire, so that the vehicle owner can obtain a better user experience.

At this time, the vehicle label presentation method further includes:

acquiring and storing a term information. of the vehicle label input or transmitted by an authorized user upon receipt of a setting command transmitted by the authorized user; and

reminding the vehicle owner in a case where a remaining term of the vehicle label is shorter than a set period of time.

When the vehicle label presentation device performs reminder to the user, the reminder may be manually turned off by the user or be automatically turned off after a set reminder time is reached, so as to save electric energy.

In order to save power and at the same time facilitate user view and improve the user experience, the display brightness of the display may be adjusted according to the ambient brightness. At this time, displaying the stored vehicle label on the display further includes:

detecting an ambient brightness through a light sensor such as an infrared light sensor or a sunlight sensor, and adjusting the display brightness of the display according to the detection result.

Usually, each vehicle has a plurality of vehicle labels that need to be presented. The plurality of vehicle labels may be stored in one device, and when displayed, the plurality of vehicle labels may be displayed simultaneously in different areas of the display, or may be displayed alternately on the display. When transmitted through a wireless signal, all the vehicle labels may be transmitted, or a corresponding vehicle label is transmitted to a vehicle label inspection device in accordance with the read command, such that more convenient viewing of the vehicle labels is achieved. For example, for the environment protection department that checks the eco-label of the vehicle, the read command transmitted thereby is directed to the eco-label. At this time, it is possible to transmit only the eco-label to the vehicle label inspection device, without transmitting other labels such as the annual inspection label.

When a plurality of vehicle labels are stored, displaying the stored vehicle label on the display specifically includes:

displaying the plurality of vehicle labels simultaneously in different areas of the display, or displaying the respective vehicle labels alternately on the display.

When a plurality of vehicle labels are stored, transmitting the stored vehicle label through a wireless signal specifically includes:

acquiring a read command through a wireless signal; and

transmitting a corresponding vehicle label to a vehicle label inspection device according to the read command.

The vehicle label presentation method provided by the present disclosure will be described in detail below with reference to specific embodiments.

When the user uses the vehicle label presentation device for the first time, the vehicle label presentation device is initialized. The issuing authority writes the vehicle label into the vehicle label presentation device, and the user places the device at a designated position of the windshield. The user may set the device to display the vehicle labels all the time, or may set the device to start displaying the vehicle labels upon receipt of a presentation command or upon detection of a read command through a wireless signal.

When the vehicle label presentation device receives a presentation command or detects a read command through the wireless signal, the stored vehicle label is displayed through a display, and after a set display time is reached, the display is automatically turned off, so as to save electric energy.

When the vehicle label presentation device performs reminder to the user, the reminder may be manually turned off by the user or be automatically turned off after a set reminder time is reached, so as to save electric energy.

The department that needs to read the vehicle label may read the vehicle label using a special vehicle label inspection device. In a mode in which the vehicle label is not always presented by the vehicle label presentation device, when the read command transmitted by the vehicle label inspection device is detected, the stored vehicle label is displayed on the display and/or transmitted through a wireless signal. If the stored vehicle label is displayed on the display, the display is automatically turned off after a set display time is reached, so as to save electric energy.

It should be noted that although the operations of the method of the present disclosure are described in a particular order in the drawings, this does not require or imply that such operations must be performed in that particular order, or that all illustrated operations must be performed to achieve the desired results. Instead, the steps illustrated in the flowcharts may be executed in another order. Additionally or alternatively, certain steps may be omitted, multiple steps may be combined into one step, and/or one step may be divided into multiple steps.

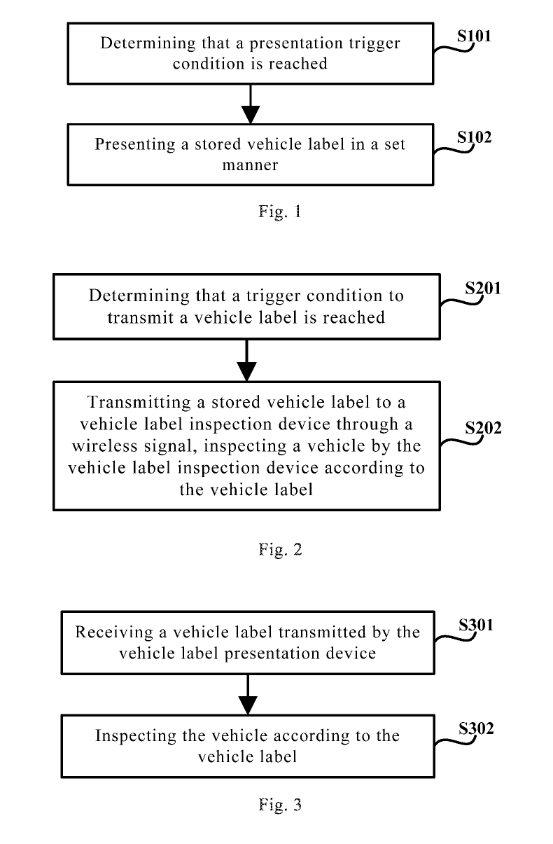

An exemplary embodiment of the present disclosure also provides a vehicle label presentation method for a solution of transmitting a vehicle label to a vehicle label inspection device. As shown in FIG. 2, the vehicle label presentation method includes:

Step S201, determining a trigger condition to transmit a vehicle label; and

Step S202, transmitting a stored vehicle label to a vehicle label inspection device through a wireless signal, inspecting a vehicle by the vehicle label inspection device according to the vehicle label.

By this method, the display of the vehicle label on the display is not required, and the transmission of the vehicle label is performed only through a wireless signal, and blocking of the front windshield is completely avoided.

The trigger condition to transmit the vehicle label specifically includes at least one of the following conditions:

turning on a device;

receiving a command to transmit a vehicle label; and

acquiring a read command transmitted by the vehicle label inspection device through a wireless signal.

Accordingly, as shown in FIG. 3, the method of inspecting a vehicle label by a vehicle label inspection device includes:

Step S301, receiving the vehicle label transmitted by the vehicle label presentation device; and

Step S302, inspecting a vehicle according to the vehicle label.

In order to reduce power consumption of the vehicle label presentation device, the method further includes the following step prior to step S301:

transmitting a read command to the vehicle label presentation device.

The vehicle label presentation device may then transmit the stored vehicle label after receiving the read command.

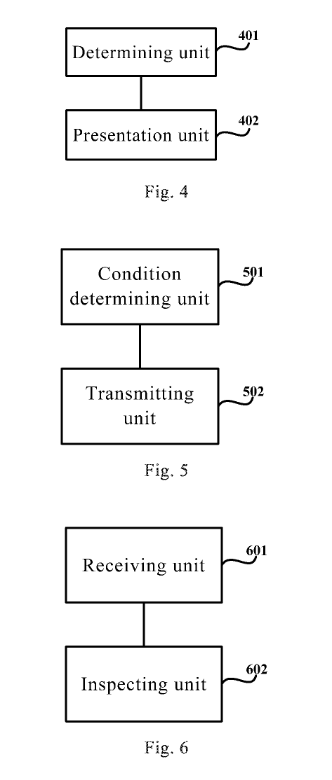

The present disclosure also provides a vehicle label presentation device accordingly. As shown in FIG. 4, the vehicle label presentation device includes:

a determining unit 401 configured to determine that a presentation trigger condition is reached; and

a presentation unit 402 configured to present a stored vehicle label in a set manner.

In an exemplary embodiment of the present disclosure, the presentation unit 402 is specifically configured to display a stored vehicle label on a display and/or to transmit the stored vehicle label through a wireless signal. As described above, in order to make the display better fit the windshield and to avoid blocking of the windshield for better display effect, the display may be a display made of a transparent flexible display material.

As described above, the presentation trigger condition specifically includes at least one of the following conditions:

turning on a device;

receiving a presentation command; and

detecting a read command through a wireless signal.

In an exemplary embodiment of the present disclosure, the vehicle label presentation device further includes:

a setting unit configured to acquire and store a vehicle label input or transmitted by an authorized user upon receipt of a setting command transmitted by the authorized user.

Further, the setting unit is also configured to:

acquire and store a term information of the vehicle label input or transmitted by an authorized user upon receipt of a setting command transmitted by the authorized user; and

reminding a vehicle owner when a remaining term of the vehicle label is shorter than a set period of time.

In an exemplary embodiment of the present disclosure, the presentation unit 402 is further configured to:

when displaying a stored vehicle label on the display, detect an ambient brightness through a light sensor such as an infrared light sensor or a sunlight sensor, and adjust the display brightness of the display according to the detection result.

Further, when a plurality of vehicle labels are stored, the presentation unit 402 displaying the stored vehicle labels on the display specifically includes:

displaying the plurality of vehicle labels simultaneously in different areas of the display, or displaying the respective vehicle labels alternately on the display.

When a plurality of vehicle labels are stored, the presentation unit 402 transmitting the stored vehicle labels through a wireless signal specifically includes:

acquiring a read command through a wireless signal; and

transmitting a corresponding vehicle label to a vehicle label inspection device according to the read command.

In an exemplary embodiment of the present disclosure, the determining unit 401, the presentation unit 402 or the setting unit may be implemented as a DSP chip or an embedded chip. However, the present disclosure is not limited thereto, and the determining unit 401, the presentation unit 402 or the setting unit may also be any other device or processing circuit capable of data processing.

It should be understood that the respective units included in the vehicle label presentation device are corresponding to the respective steps of the vehicle label presentation method described with reference to FIG. 1. Thus, the operations and features described above in relation to the vehicle label presentation method are equally applicable to the vehicle label presentation device and the units included therein, and which will not be described here. The corresponding units in the vehicle label presentation device may cooperate with units in the corresponding electronic device to implement the solutions of the above-described exemplary embodiments.

An exemplary embodiment of the present disclosure also provides a vehicle label presentation device for a solution of transmitting a vehicle label to a vehicle label inspection device. As shown in FIG. 5, the vehicle label presentation device includes:

a condition determining unit 501 configured to determine that a trigger condition to transmit a vehicle label is reached; and

a transmitting unit 502 configured to transmit a stored vehicle label to a vehicle label inspection device through a wireless signal, inspecting a vehicle by the vehicle label inspection device according to the vehicle label.

In an exemplary embodiment of the present disclosure, the trigger condition to transmit the vehicle label specifically includes at least one of the following conditions:

turning on a device;

receiving a command to transmit the vehicle label; and

acquiring a read command transmitted by the vehicle label inspection device through a wireless signal.

An exemplary embodiment of the present disclosure also provides a vehicle label inspection device accordingly. As shown in FIG. 6, the vehicle label inspection device includes:

a receiving unit 601 configured to receive a vehicle label transmitted by the vehicle label presentation device; and

an inspecting unit 602 configured to inspect the vehicle according to the vehicle label.

In an exemplary embodiment of the present disclosure, the receiving unit 601 is further configured to:

transmit a read command to the vehicle label presentation device prior to receiving the vehicle label transmitted by the vehicle label presentation device.

In an exemplary embodiment of the present disclosure, the condition determining unit 501, the presentation unit 502, the receiving unit 601 or the inspecting unit 602 may be implemented as a DSP chip or an embedded chip. However, the present disclosure is not limited thereto, the condition determining unit 501, the presentation unit 502, the receiving unit 601 or the inspecting unit 602 may also be any other device or processing circuit capable of data processing.

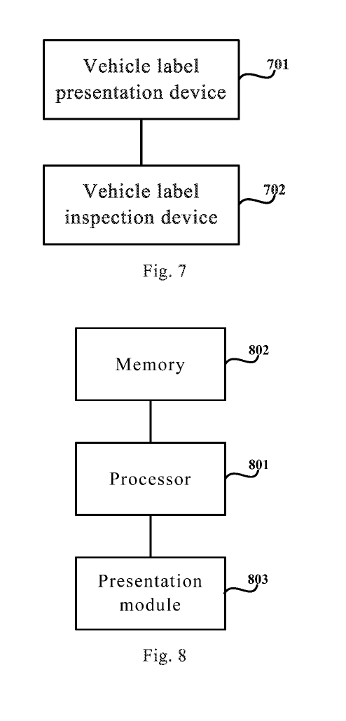

An exemplary embodiment of the present disclosure also provides a vehicle label presentation system accordingly. As shown in FIG. 7, the vehicle label presentation system includes a vehicle label presentation device 701 and a vehicle label inspection device 702. The vehicle label presentation device 701 is configured to transmit a stored vehicle label to the vehicle label inspection device 702 through a wireless signal when it is determined that a trigger condition to transmit a vehicle label is reached. The vehicle label inspection device 702 is configured to receive the vehicle label transmitted by the vehicle label presentation device 701, and inspect a vehicle according to the vehicle label.

An exemplary embodiment of the present disclosure also provides a vehicle label presentation apparatus accordingly. As shown in FIG. 8, the apparatus includes a processor 801, a memory 802, and a presentation module 803.

The memory 802 includes an instruction executable by the processor 801 such that the processor 801 executes the vehicle label presentation method provided by the exemplary embodiments of the present disclosure.

The presentation module 803 may be a display and/or a wireless communication module, depending on the presentation method.

The processor 801 and the memory 802 may be combined with the processor and memory of the vehicle, i.e., using the processor and memory of the vehicle as the processor and memory of the vehicle label presentation apparatus. At this time, the vehicle power source may also be used to supply power to the vehicle label presentation apparatus.

The vehicle label presentation apparatus may also be powered by solar energy alone. It should be understood that the vehicle label presentation apparatus provided by the present disclosure may be powered by one or more of a solar energy, a battery, and a vehicle power source.

If the vehicle label presentation apparatus can transmit a stored vehicle label through a wireless signal, the vehicle label presentation apparatus also has a wireless communication function and includes a wireless communication module to communicate wirelessly with the vehicle label inspection device or a writing device.

In particular, according to the above-described exemplary embodiments of the present disclosure, the processes described above with reference to FIG. 1, 2, or 3 may each be implemented as a computer software program. For example, an exemplary embodiment of the present disclosure may include a computer program product having a computer program tangibly embodied on a machine readable medium, the computer program having a program code for executing the method as illustrated in FIG. 1, 2 or 3. In such an exemplary embodiment, the computer program may be downloaded from the network and installed, and/or installed from a removable medium.

The flowcharts and block diagrams in the drawings illustrate the implementable architectures, functions and operations of the systems, methods and computer program products of various embodiments of the present disclosure. In this regard, each block of the flowchart or block diagram can represent a module, a program segment, or a portion of code that includes one or more executable instructions for implementing the regulated logic function. It should also be noted that, in some alternative implementations, the functions noted in the blocks may also occur in a different order than the one illustrated in the drawings. For example, two successively illustrated blocks may in fact be executed substantially in parallel, and they may sometimes be executed in the reverse order, depending upon the functionality involved. It should be noted that each block of the block diagrams and/or flowcharts, and combinations of blocks in the block diagrams and/or flowcharts, can be implemented in a dedicated hardware-based system that performs the specified function or operation, or be implemented by a combination of the dedicated hardware and computer instructions.

The units or modules involved in the embodiments of the present disclosure may be implemented by software or by hardware. The described units or modules may also be provided in the processor, for example, it may be described as a processor including an XX unit, a YY unit, and a ZZ unit. The names of these units or modules do not constitute a limitation on the unit or the module itself in some cases. For example, the XX unit may also be described as “a unit for XX”.

It should be understood that the above embodiments are merely exemplary embodiments for the purpose of illustrating the principle of the disclosure, and the disclosure is not limited thereto. Various modifications and improvements can be made by a person having ordinary skill in the art without departing from the spirit and essence of the disclosure. Accordingly, all of the modifications and improvements also fall into the protection scope of the disclosure.

What is claimed is:

1. A vehicle label presentation method, comprising:
determining that a presentation trigger condition is reached; and
presenting a stored vehicle label in a set manner.

2. The vehicle label presentation method according to claim 1, wherein,
the step of presenting a stored vehicle label in a set manner comprises:
displaying the stored vehicle label on a display.

3. The vehicle label presentation method according to claim 1, wherein,
the step of presenting a stored vehicle label in a set manner comprises:
transmitting the stored vehicle label through a wireless signal.

4. The vehicle label presentation method according to claim 1, wherein,
the presentation trigger condition comprises at least one of the following conditions:
turning on a device;
receiving a presentation command; and
detecting a read command through a wireless signal.

5. The vehicle label presentation method according to claim 1, further comprising:
acquiring and storing a vehicle label input or transmitted by an authorized user in a case where a setting command transmitted by the authorized user is received.

6. The vehicle label presentation method according to claim 5, further comprising:
acquiring and storing a term information of the vehicle label input or transmitted by the authorized user in a case where the setting command transmitted by the authorized user is received; and
reminding a vehicle owner in a case where a remaining term of the vehicle label is shorter than a set period of time.

7. The vehicle label presentation method according to claim 2, wherein,
in a case where a plurality of vehicle labels are stored, displaying the stored vehicle label on a display comprises one of the following manners:
displaying the plurality of vehicle labels simultaneously in different areas of the display; and
displaying the plurality of vehicle labels alternately on the display.

8. The vehicle label presentation method according to claim 3, wherein,
in a case where a plurality of vehicle labels are stored, transmitting the stored vehicle label through a wireless signal comprises:
acquiring a read command through the wireless signal; and
transmitting a corresponding vehicle label to a vehicle label inspection device according to the read command.

9. A vehicle label presentation device, comprising:
a determining unit configured to determine that a presentation trigger condition is reached; and
a presentation unit configured to present a stored vehicle label in a set manner.

10. The vehicle label presentation device according to claim 9, wherein,
the presentation unit is configured to display the stored vehicle label on a display.

11. The vehicle label presentation device according to claim 9, wherein,
the presentation unit is configured to transmit the stored vehicle label through a wireless signal.

12. The vehicle label presentation device according to claim 9, wherein,
the presentation trigger condition comprises at least one of the following conditions:
turning on a device;
receiving a presentation command; and
detecting a read command through a wireless signal.

13. The vehicle label presentation device according to claim 9, further comprising:
a setting unit configured to acquire and store a vehicle label input and transmitted by an authorized user in a case where a setting command transmitted by the authorized user is received.

14. The vehicle label presentation device according to claim 13, wherein,
the setting unit is further configured to acquire and store a term information of the stored vehicle label, and remind a vehicle owner in a case where the remaining term of the vehicle label is shorter than a set period of time.

15. The vehicle label presentation device according to claim 10, wherein,
in a case where a plurality of vehicle labels are stored, the presentation unit is configured to display the stored vehicle label on the display in one of the following manners:
displaying the plurality of vehicle labels simultaneously in different areas of the display; and
displaying the plurality of vehicle labels alternately on the display.

16. The vehicle label presentation device according to claim 11, wherein,
in a case where a plurality of vehicle labels are stored, the presentation unit is configured to acquire a read command through a wireless signal, and transmit a corresponding vehicle label to a vehicle label inspection device according to the read command.

17. The vehicle label presentation device according to claim 10, wherein,
the display is a display formed of a flexible transparent material.

18. The vehicle label presentation device according to claim 10, further comprising:
a light sensor configured to detect an ambient brightness to adjust a display brightness of the display.

19. A vehicle label presentation system, comprising:
the vehicle label presentation device according to claim 9 configured to transmit a stored vehicle label through a wireless signal in a case where it is determined that a trigger condition to transmit a vehicle label is reached; and
a vehicle label inspection device configured to receive the vehicle label transmitted by the vehicle label presentation device, and inspect a vehicle according to the vehicle label.

20. The vehicle label presentation system according to claim 19, wherein,
the presentation trigger condition to transmit a vehicle label comprises at least one of the following conditions:
turning on a device;
receiving a command to transmit the vehicle label; and
acquiring a read command transmitted by the vehicle label inspection device through the wireless signal.
